(19) United States
(12) Patent Application Publication
(10) Pub. No.: US 2014/0020201 A1
(43) Pub. Date: Jan. 23, 2014

(54) CLEANING SYSTEM FOR UNDERWATER CAMERA

(71) Applicant: Christopher Bunt, Kitchener (CA)

(72) Inventor: Christopher Bunt, Kitchener (CA)

(21) Appl. No.: 13/945,848

(22) Filed: Jul. 18, 2013

(30) Foreign Application Priority Data
Jul. 20, 2012 (CA) 2783636

(51) Int. Cl. B08B 1/00

(52) U.S. Cl. CPC B08B 1/001
USPC 15/250.31

(57) ABSTRACT

A cleaning device for cleaning a surface of an underwater optical apparatus comprises a motor and a wiper arm having a wiper blade for cleaning a surface of the underwater optical apparatus. The motor is drivingly coupled to the wiper arm to drive reciprocal motion of the wiper arm, and the motor is isolated from the surrounding water by a waterproof enclosure. At least a portion of the waterproof enclosure is flexible to accommodate the reciprocal motion of the wiper arm.

### TECHNICAL FIELD

The present invention relates to surface cleaning devices for underwater cameras and other optical sensors.

### BACKGROUND

Underwater cameras and sensor surfaces used for scientific purposes and placed both in marine and freshwater environments are known to accumulate debris and therefore must be cleaned regularly in order to maintain the field of view, good image quality and accurate data collection. However, human access may be inconvenient, impracticable or dangerous and it may be impossible to maintain cleanliness and image quality of a camera lens due to permanent or semi-permanent placement in remote, deep, or unsafe locations. Therefore, an automatic lens cleaning device that removes contaminants (dirt, algae, other biological growth or bio-film) from the lens effectively without obscuring the image and maintaining a high quality field of view is needed.

Although automatic cleaning systems for cameras are known, such as that described in U.S. Patent Application Number 20020139394A1, none are suitable for underwater use. Therefore, it is desirable to improve the way of maintaining cleanliness of a lens for underwater cameras and other optical systems that are protected by a waterproof enclosure.

### SUMMARY

A surface cleaning device for underwater cameras and other optical sensors wipes the camera lens or other surface in order to maintain a high quality field of view, free from obstructions such as debris including algal growth, diatoms, macro invertebrates, filamentous particles and/or bio-film in both marine and freshwater environments.

A cleaning device for cleaning an underwater optical apparatus comprises a motor and a wiper arm having a wiper blade for cleaning a surface of the underwater optical apparatus. The motor is drivingly coupled to the wiper arm to drive reciprocal motion of the wiper arm and the motor is isolated from ambient by a waterproof enclosure, at least a portion of which is flexible to accommodate reciprocal motion of the wiper arm.

In one embodiment, the waterproof enclosure comprises a rigid waterproof housing and a flexible waterproof boot. In this embodiment, the motor is disposed within the rigid waterproof housing and is drivingly coupled to the wiper arm through an aperture in the rigid waterproof housing, and the flexible waterproof boot encapsulates the aperture and is sealed to the rigid waterproof housing to isolate the motor from ambient.

### BRIEF DESCRIPTION OF THE DRAWINGS

These and other features of the invention will become more apparent from the following description in which reference is made to the appended drawings wherein:

FIG. 1 is a detailed side cross-sectional side view of an exemplary cleaning device mounted on an underwater camera, only a portion of which is shown in FIG. 1;

FIG. 2 is a detailed top view of the cleaning device and underwater camera of FIG. 1;

FIG. 3 is a top view of the cleaning device and underwater camera of FIG. 1;

FIGS. 4A and 4B show, respectively, a top view and side view of the cleaning device and underwater camera of FIG. 1; and

FIG. 5 shows a flowchart for an exemplary control program.

### DETAILED DESCRIPTION

In the following detailed description and in the figures of the drawings, like elements are identified with like reference numerals.

A cleaning device for cleaning underwater camera lenses and other surfaces that require regular cleaning can wipe the camera lens (or other surface) in order to maintain a high quality field of view, free from obstructions such as debris including algal growth, diatoms, macro invertebrates, filamentous particles, sediment and/or bio-film known to occur in both marine and freshwater environments. An individual is not required to manually clean the lens, and the lens can be cleaned in remote situations where accessibility is dangerous or impossible. Moreover, the device can be used in both marine and freshwater environments. Cleaning devices as described herein can be built onto camera housings with a hard wired conduit to supply power. Alternatively, the cleaning devices can attach to any underwater camera housing with a dedicated power-line in an underwater conduit.

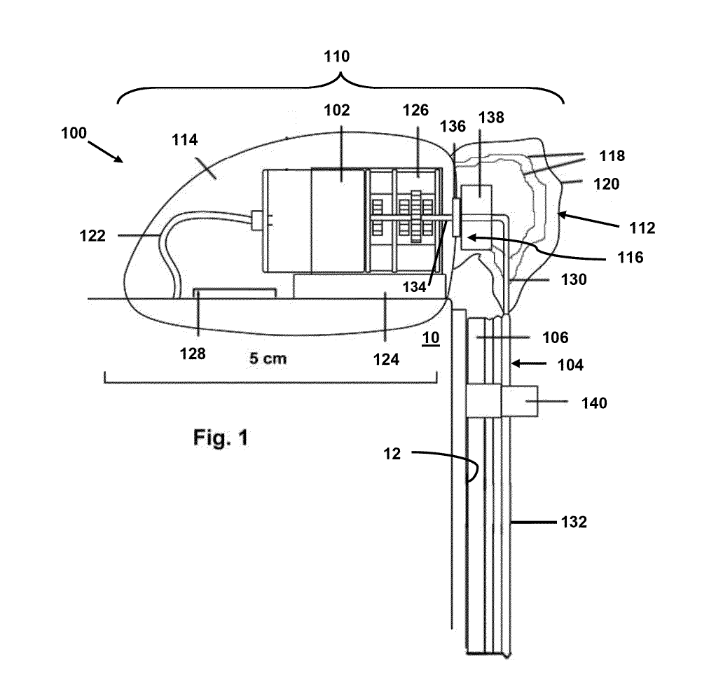

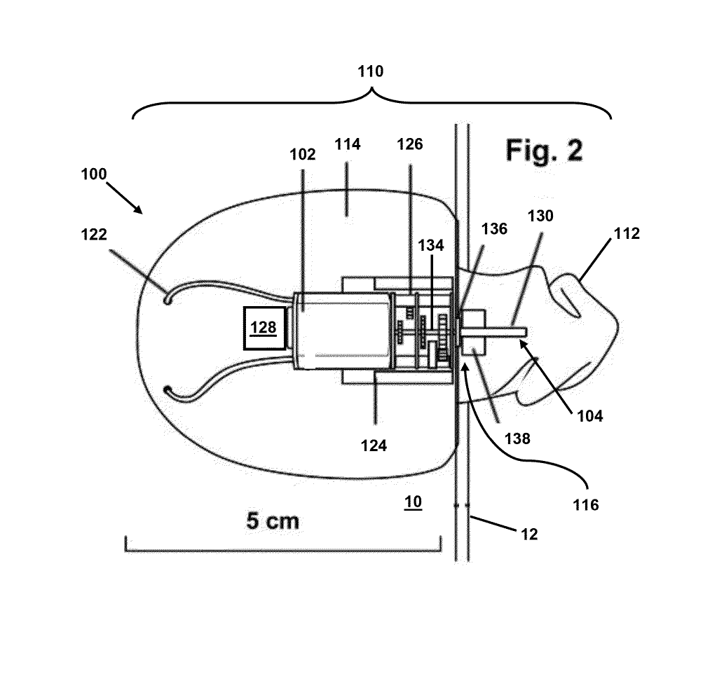

FIGS. 1 and 2 show an exemplary cleaning device, indicated generally by the reference numeral 100, mounted on an exemplary underwater optical apparatus, in this case an underwater camera 10. The cleaning device 100 comprises a motor 102, a wiper arm 104 having a wiper blade 106 for cleaning a surface 12, such as a lens, of the underwater camera 10, and a waterproof enclosure 110. The motor 102 is drivingly coupled to the wiper arm 104 to drive reciprocal motion of the wiper arm 104, and a portion 112 of the waterproof enclosure 110 is flexible to accommodate reciprocal motion of the wiper arm 104. The waterproof enclosure 110 isolates the motor from ambient, i.e. the water in which the camera 10 and cleaning device 100 are immersed.

In the illustrated embodiment, the waterproof enclosure 110 comprises a rigid waterproof housing 114 and a flexible waterproof boot 112. The motor 102 is disposed within the rigid waterproof housing 114, and is drivingly coupled to the wiper arm 104 through an aperture 116 (FIG. 1) in the rigid waterproof housing 114. The flexible waterproof boot 112 encapsulates the aperture 116 and is sealed to the rigid waterproof housing 114 to isolate the motor 102 from ambient. The rigid waterproof housing 114 may be formed, for example, from acrylic or polycarbonate material, preferably transparent as shown in the drawings, and the waterproof protective boot 112 is preferably formed from multiple layers. In the illustrated embodiment, the waterproof protective boot 112 comprises two inner layers 118 of Neolon™ (nylon fabric laminated to neoprene rubber) and an outer layer 120 of suitable fabric such as Nitex™. In other embodiments, the rigid waterproof housing may be omitted and the entire waterproof enclosure may be formed from a flexible waterproof boot.

The exemplary cleaning device 100 may further comprise a robot controller (not shown), with the motor 102 connected to the output of the robot controller. The robot controller can be disposed within the waterproof enclosure, or, as in the illustrated embodiment, may be positioned externally thereof by using CAT5e cable. The robot controller preferably incorporates both a micro controller, used to run a control program, and a motor controller, which sends the voltage to power the motor 102 and thereby intermittently drive the wiper arm 104. The robot controller may be, for example, a robot controller offered under the trademark “Baby Orangutan”.

The motor 102 that drives the wiper arm 104 is powered by an external power source (not shown) either from the camera power supply or from an independent external conduit. Two power lines 122 (in this example 22 gauge wire diameter, insulated solid core) connect to the motor 102 from the robot controller in order to power the motor 102 which in turn drives the wiper arm 104. In the illustrated embodiment, the motor 102 is drivingly coupled to the wiper arm via a gearbox 126, and both the motor 102 and the gearbox 126 are disposed inside the rigid waterproof housing 114 and supported by a rectangular acrylic cradle 124. In other embodiments, the gearbox may be omitted. A silica packet 128 is also disposed inside the rigid waterproof housing 114 to capture moisture that infiltrates the waterproof enclosure 110. Flexible waterproof sealant is used to attach the rigid waterproof housing 114 and all associated parts to the housing of the camera 10.

In the illustrated embodiment, the wiper arm 104 comprises a bent solid metal shaft 130 and a hollow metal shaft 132, both preferably of brass. The hollow metal shaft 132 carries the wiper blade 106. A driveshaft 134 extends from the gearbox 126 through the aperture 116, and is supported in the aperture 116 by a bearing 136 embedded in the rigid waterproof housing 114 (e.g. glued), and the bent solid metal shaft 130 is connected to the driveshaft 134 by a coupler 138, also preferably of brass. The bent solid metal shaft 130 is inserted into the hollow metal shaft 132 creating an 85-90 degree angle between the wiper blade 106 and the end of the bent solid metal shaft 130 that mates with the coupler 138, thereby creating pressure and tension so that the wiper blade 106 properly engages the surface 12. The section of the wiper arm 104 between the wiper blade 106 and the rigid waterproof housing 114 is covered by the flexible waterproof boot 112. Thus, the connection between the driveshaft 134 and the wiper arm 104, including the aperture 116, bearing 136 and coupler 138, is protected by the flexible waterproof boot 112, which is sealed at one end to the rigid waterproof housing 114 and at the other end to the bent solid metal shaft 130 to provide a watertight seal and protection from abrasion. The foregoing is merely one exemplary construction, and other constructions are also contemplated. For example, where the gearbox is omitted, the shaft of the motor may be bent to form the wiper arm. Similarly, the end of the flexible waterproof boot may be sealed to the wiper arm at any suitable position, or if the driveshaft (or the shaft of the motor if the gearbox is omitted) extends sufficiently beyond the rigid waterproof housing, the end of the flexible waterproof boot may be sealed to the driveshaft (or motor shaft).

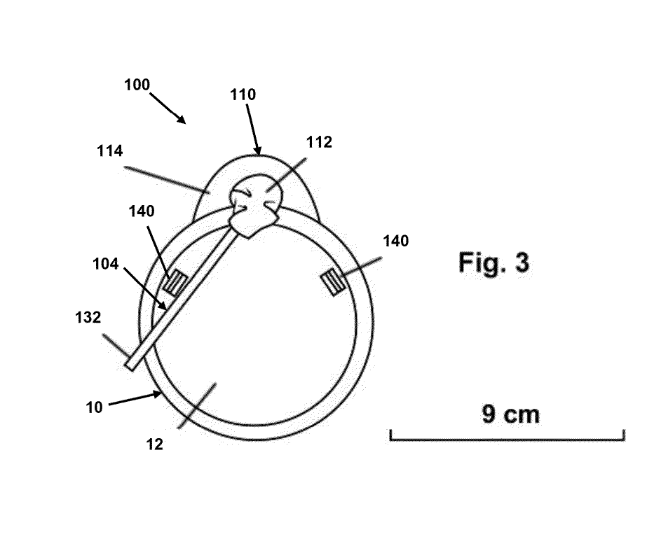

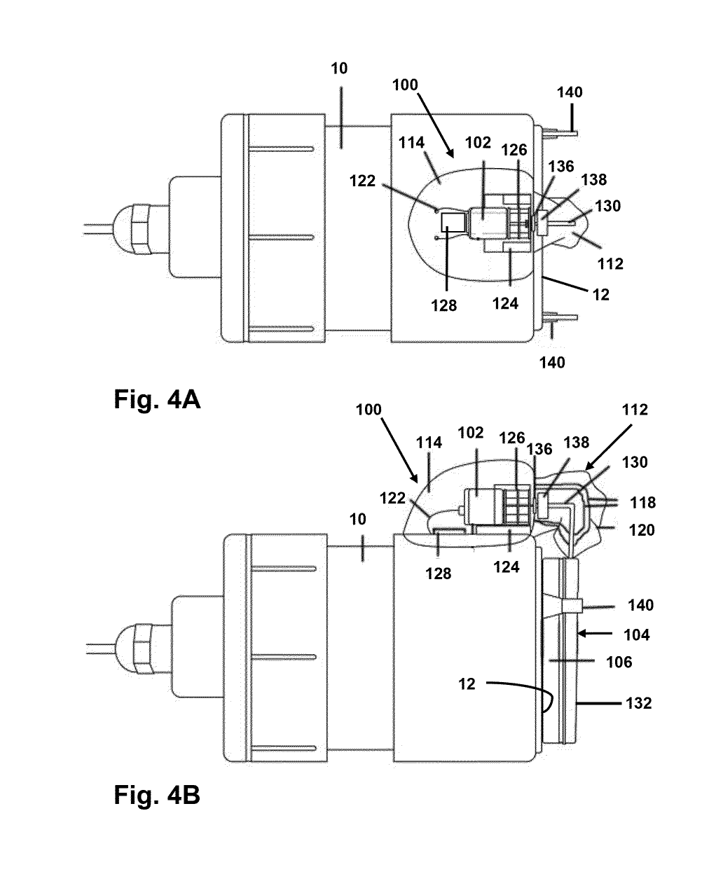

As shown in FIGS. 3, 4A and 4B, two wiper stoppers 140 are located on either side of the underwater camera 10 or other optical device, outside of the field of view, to inhibit the wiper arm 104 from extending off of the surface 12. The wiper stoppers 140 may be secured directly to the surface 12, for example using epoxy. Alternatively or additionally, the motor may be a stepper motor, or the gearbox may be configured so that rotation of the motor in a single direction drives the wiper arm to move back and forth.

Preferably, all parts are waterproofed using flexible marine sealant.

Constant motion of a wiper arm may cause irritation to viewers and decrease the life of moving parts and therefore a wiper s of the intermittent type is preferred. The robot controller supplies the motor 102 with a controlled voltage (for example 6-12 volts DC) in order to drive the wiper arm 104 on a pre-programmed duty cycle. This allows intermittent movement of the wiper arm 104 forward and backward across the surface 12 from wiper stopper 140 to wiper stopper 140, thereby maintaining the field of view and minimizing camera maintenance. The duty cycle is based on environmental conditions such as temperature, marine or freshwater environments and nutrient loading. Typically the robot controller executes a computer program, which may be written in C++, to run the motor 102 on an 8 to 12 hour duty cycle in which the robot controller sends 6-12 volts DC to the motor 102 to move the wiper arm forward (positive voltage) and backward (negative voltage).

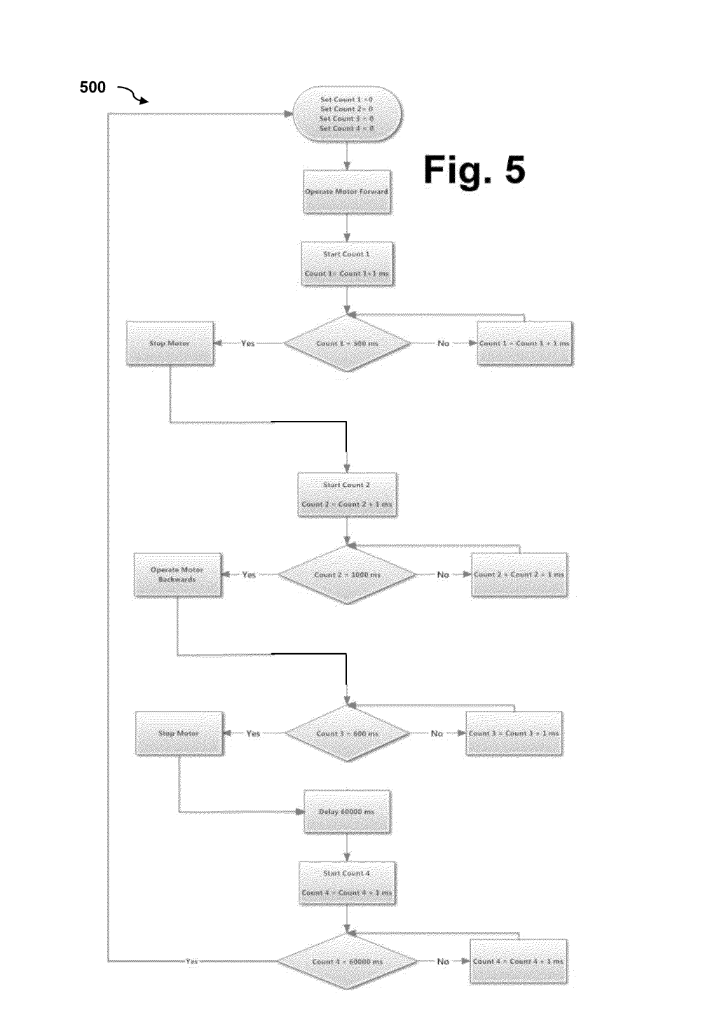

FIG. 5 is an exemplary flow chart 500 for a program in the C++ based programming language which operates and runs the cleaning device 100. The motor speed, run time forward, run time backwards, set number of wipes per cycle, set number of delay periods to repeat before main loop and set sleep time between cycles are included in the program. The program tells the device to operate the motor forward for a desired time, in the exemplary embodiment 500 milliseconds (ms). After the set amount of time the program tells the motor to stop and runs a delay time period to separate time between wipes of 1000 ms. The program then tells the motor to operate the device backwards for a desired time frame (e.g. 600 ms) and then the program tells the motor to stop. This marks the end of the cycle in which the program is told to sleep for a desired period of time to separate the cycles (e.g. 60,000 ms). The program is designed to ensure that the wiper arm is self-parking and auto correcting to ensure it does not obstruct the field of view and cause annoyance to the viewer. This is achieved by driving the wiper arm into the wiper stoppers.

While the embodiment described herein employs a robot controller to control the motor 102, in other embodiments, the motor 102 may be controlled manually, for example by way of a remote switch coupled to the motor 102, with an operator activating the motor to wipe the surface when deterioration in image quality is observed. Optionally, even where a robot controller is used, a reset feature may be provided allowing an operator to reset the control program and run it from the beginning.

The dimensions shown in the drawings are exemplary only, and do not imply any limitation.

One or more currently preferred embodiments have been described by way of example. It will be apparent to persons skilled in the art that a number of variations and modifications can be made without departing from the scope of the invention as defined in the claims.

What is claimed is:

1. A cleaning device for cleaning an underwater optical apparatus, comprising:
a motor;
a wiper arm having a wiper blade for cleaning a surface of the underwater optical apparatus;
the motor drivingly coupled to the wiper arm to drive reciprocal motion of the wiper arm; and
the motor being isolated from ambient by a waterproof enclosure at least a portion of which is flexible to accommodate the reciprocal motion of the wiper arm.

2. The cleaning device of claim 1, wherein:
the waterproof enclosure comprises a rigid waterproof housing and a flexible waterproof boot;
the motor is disposed within the rigid waterproof housing;
the motor is drivingly coupled to the wiper arm through an aperture in the rigid waterproof housing; and
the flexible waterproof boot encapsulates the aperture and is sealed to the rigid waterproof housing to isolate the motor from ambient.
